(19) United States
(12) Patent Application Publication
(10) Pub. No.: US 2005/0182880 A1
(43) Pub. Date: Aug. 18, 2005

(54) System and method of switching display status

(76) Inventor: Jia-Shiung Kuo, Taipei (TW)

Correspondence Address: BIRCH STEWART KOLASCH & BIRCH, PO BOX 747, FALLS CHURCH, VA, 22040-0747, US

(21) Appl. No.: 10/778,235

(22) Filed: Feb. 17, 2004

(51) Int. Cl. G06F 13/24; G06F 9/00

(52) U.S. Cl. 710/261; 713/100

(57) ABSTRACT

A system of switching the display status and its method are disclosed to switch the display status of an external display unit of a portable electronic device. A connect port is used to connect with the corresponding external display unit. An input signal is triggered to generate a trigger signal using a level unit. It enables a keyboard control (KBC) unit to send a system control interrupt (SCI) to notify the display control unit to produce the corresponding output signal. The output signal is used to switch the display status of the external display unit.

### BACKGROUND OF THE INVENTION

1. Field of Invention

The invention relates to a system of switching the display status and the method for the same. In particular, it relates to a system of switching the display status of a portable electronic device and the method for the same.

2. Related Art

Taking Microsoft operating systems (OS) as an example, there are several methods for outputting a display signal to an external display unit from a portable electronic device so that the external display unit also has a screen to display the switching display status. They include: (1) hot keys; (2) setting the external display unit as its primary display unit; and (3) changing the display unit selections. The details are as follows.

(1) Hot keys: The external display unit is connected to the portable electronic device. The user presses a hot key for swtiching the screen. The external display unit then switches the display condition according to the setting value of the hot key. However, not all the portable electronic devices support this hot key function.

(2) Setting the external display unit as its primary display unit: The external display unit is connected to the portable electronic device before power on. The basic input/output system (BIOS) follows the PC2100 System Design Guide specified by Intel and Microsoft to detect whether an external display unit exists during the power on period. The external display unit is set as the primary display unit. Therefore, the connected external display unit immediately displays a screen after power on. The above method, however, does not apply to the case when the external display unit is a television (TV).

(3) Changing the display unit selections: If one wants to switch the display screen for an external TV display unit from no output screen to an output screen, the system can execute a display unit resetting procedure by entering a display contents selection window in the OS. The operating procedure is as follows: step 1, click the “start” button; step 2, click the “settings” button; step 3, click the “control panel” button; step 4, click the “display” icon; step 5, click the “settings” tab; step 6, click the “advanced” button; step 7, click the “monitor” tab; step 8, click the “OK” button; and step 9, click “restart system” button to reboot the system.

The above-mentioned methods are so complicated that users without much computer background may encounter much inconvenience and trouble. Not only do the users have to know much about the computer, the users have to know that the display status of switching the external display unit can be achieved by setting the driver and using the hot key. Moreover, the operational procedure is too complicated, the user interface (UI) is not intuitive enough, and there are too several selections for adjusting in the driver menu. This requires the user to understand which selection items to use in order to complete the setting procedure. Even if the user has selected all the correction items, there are still several steps to go through. The system eventually may have to be rebooted. The setting time from the beginning to the end is about five minutes. Furthermore, if the built-in display of the portable electronic device cannot be correctly display the screen, the external display unit becomes more important. Suppose the device does not have the hot key function. It is even harder to switch the display if there is no display screen to start with.

Therefore, it is highly desirable if a simple and convenient setting method can be provided for portable electronic devices to switch the display status of an external display unit. When the built-in display unit is out of order, the user can easily replace with an external display unit to continue his or her work. This definitely has a great market value.

### SUMMARY OF THE INVENTION

In view of the foregoing, the invention provides a system and method of switching the display status for portable electronic deivces to use an external display unit.

A connect port is connected to the external display unit. A signal is generated for a voltage level unit to produce a trigger signal. The trigger signal enables the keyboard control (KBC) unit to send out a system control interrupt (SCI), notifying a display control unit to produce the corresponding output signal. The output signal switches the display status of the external display unit.

### BRIEF DESCRIPTION OF THE DRAWINGS

The invention will become more fully understood from the detailed description given hereinbelow illustration only, and thus are not limitative of the present invention, and wherein:

FIG. 1 is a block diagram of the system structure in the first embodiment of the invention; and

FIG. 2 is a flowchart of the disclosed display status switching method in the first embodiment of the invention.

### DETAILED DESCRIPTION OF THE INVENTION

The specification discloses a system of switching the display status and the corresponding method to switch the display status of its external display unit of a portable electronic device. A connect port is connected to the external display unit. A signal is generated for a voltage level unit to produce a trigger signal. The trigger signal enables the keyboard control (KBC) unit to send out a system control interrupt (SCI), notifying a display control unit to produce the corresponding output signal. The output signal switches the display status of the external display unit.

In the embodiment of the invention, the external display unit can be a cathode ray tube (CRT) display, a liquid crystal display (LCD), a digital visual interface liquid crystal display (DVILCD), a television (TV), and so on.

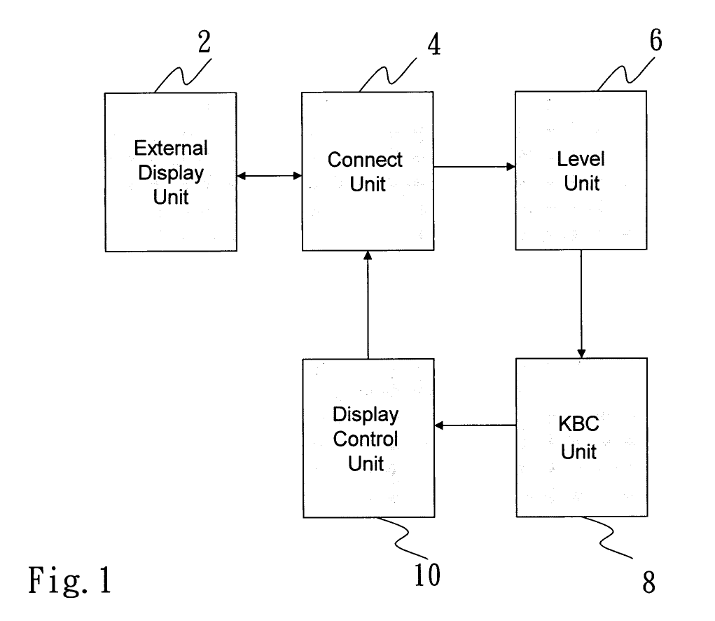

As shown in FIG. 1, the primary system function module includes (1) a connect unit 4, (2) a level unit 6, (3) a keyboard control (KBC) unit 8, and (4) a display control unit 10. We describe each of them in the following paragraphs.

(1) The connect unit 4 connects to the external display unit 2 and triggers to generate an input signal. The input signal is a high/low voltage signal. The connect unit 4 is a communication interface for the portable electronic device to transmit/receive signals to/from the external display unit 2. The connect unit 4 can be a TV-out-S-video port, a CRT port, a digital visual interface(DVI), etc.

(2) The level unit 6 connects to the connect unit 4 and produces a trigger signal according to the input signal generated by the connect unit 4. The level unit 6 is a voltage level circuit. The circuit takes the input signal from the connect unit 4 and functions as a pull low/pull high voltage circuit. When the input signal of the connect unit 4 passes through the level unit 6, the voltage of the voltage level circuit will change (high voltage−>low voltage/low voltage−>high voltage). The level unit 6 takes the above variation as a trigger signal of the KBC unit 8.

(3) The KBC unit 8 connects to the level unit 6 using a general purpose input/output (GPIO) pin. The trigger signal generated by the level unit 6 is used to produce a system control interrupt (SCI) signal that can communicate with the BIOS (Basic Input/Output System). The display control unit 10 is notified by the BIOS to produce the corresponding output signal for switching the display status of the external display unit 2. The KBC unit 8 receives the above-mentioned trigger signal via one pin of the General Purpose Input/Output (GPIO) pin.

(4) The display control unit 10 connects the KBC unit 8 and to the external display unit 2 via the connect unit 4. It produces an output signal according to the SCI signal and transmits the output signal to the external display unit 2 through the connect unit 4. To switches the display status of the external display unit 2

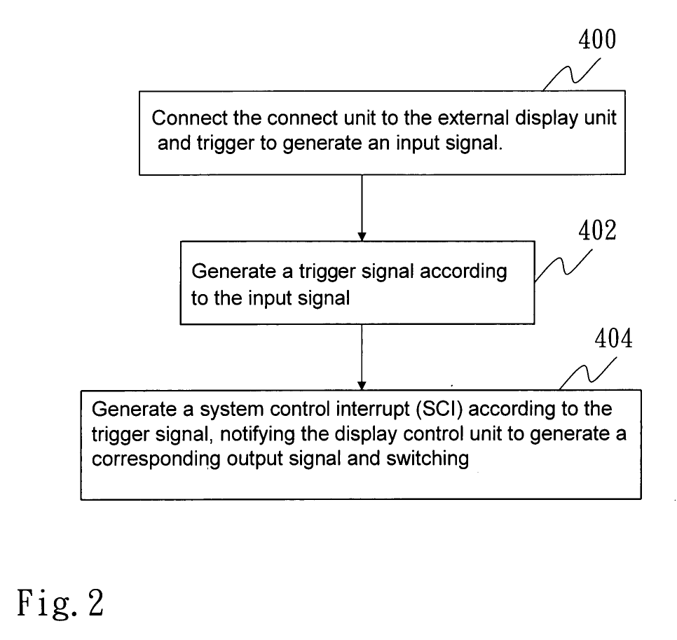

FIG. 2 shows a first embodiment of the dislcosed method. The connect unit 4 connects to the external display unit 2 and produces a high/low volatge input signal (step 400). When the input signal passes through the pull low/pull high voltage circuit in the level unit 6, the input voltage signal and the voltage circuit in the level unit 6 are opposite (the input voltage must be a low voltage if the voltage circuit is a pull high voltage, and vice versa). Thus, the voltage of the voltage circuit inside the level unit 6 varies (high voltage−>low voltage and low voltage−>high voltage). The level unit 6 follows the variation of the above voltage and generates a trigger signal for the KBC unit 8 (step 402). The KBC unit 8 generates a SCI signal according to the trigger signal. The basic input/output system (BIOS) reads the information provided by the KBC unit 8 according to its SCI signal. The information can be used to confirm that the connect unit 4 has connected to the external display unti 2. The display control unit 10 is notified according to the above information to generate a corresponding output signal.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

1. A system of switching the display status for changing the display status of an external display unit, the system comprising:
a connect unit, which connects to the external display unit and produces an input signal;
a level unit, which connects to the connect unit for generating a trigger signal according to the input signal;
a keyboard control (KBC) unit, which connects to the level unit for generating an interrupt signal according to the trigger signal; and
a display control unit, which connects to the KBC unit for changing the display status of the external display unit using the interrupt signal via the connect unit.

2. The system of claim 1, wherein the external display unit is selected from the group consisting of the cathode ray tube (CRT) display, the liquid crystal display (LCD), the digital visual interface liquid crystal display (DVILCD), and the television (TV).

3. The system of claim 1, wherein the connect unit is selected from the group consisting of the CRT port, the digital visual interface (DVI), and the TV-out-S-video port.

4. The system of claim 1, wherein the generation of the trigger signal is according to the variation of the voltage inside the level unit.

5. The system of claim 1, wherein the interrupt signal output from the KBC unit is a system control interrupt (SCI).

6. A method for switching the display status for changing the display status of an external display unit, the method comprising the steps of:
connecting the external display unit and generating an input signal;
providing a level unit and generating a trigger signal according to the input signal;
generating an interrupt signal according to the trigger signal; and
providing a display control unit and changing the display status of the external display unit according to the interrupt signal.

7. The method of claim 6, wherein the interrupt signal output from the KBC unit is a system control interrupt (SCI).

8. The method of claim 6, wherein the trigger signal is generated according to the variation of the voltage inside the level unit.
